(19) United States
(12) Patent Application Publication
(10) Pub. No.: US 2018/0261167 A1
(43) Pub. Date: Sep. 13, 2018

(54) Adaptive Method Of Clock controller And Device Thereof

(71) Applicant: Shenzhen China Star Optoelectronics Technology Co., Ltd., Shenzhen, Guangdong (CN)

(72) Inventor: Hua ZHANG, Shenzhen, Guangdong (CN)

(73) Assignee: Shenzhen China Star Optoelectronics Technology Co., Ltd., Shenzhen, Guangdong (CN)

(21) Appl. No.: 15/323,465

(22) PCT Filed: Dec. 23, 2016
(86) PCT No.: PCT/CN2016/111697

§ 371 Date: Jan. 3, 2017

(30) Foreign Application Priority Data
Aug. 26, 2016 (CN) 201610737671.5

(51) Int. Cl. G09G 3/36; G02F 1/133

(52) U.S. Cl. CPC G09G 3/36; G09G 2320/0233; G09G 2310/08; G02F 1/13306

(57) ABSTRACT

The present invention is to provide an adaptive method of clock controller and a device thereof, wherein the method is based on a clock controller, a conversion module, and a memory, and the memory is used to store original compensation data corresponding to a liquid crystal panel, and wherein the method comprises: capturing the original compensation data from the memory by the conversion module; converting the original compensation data into updated compensation data adapted to the clock controller by the conversion module; capturing the updated compensation data from the conversion module by the clock controller and outputting a screen compensated by the updated compensation data to a liquid crystal panel. By the above-mentioned manner, the present invention can adapt the same original compensation data to different clock controllers without changing the original compensation data in the memory.

### FIELD OF THE INVENTION

The present invention relates to a technology of liquid crystal display, and more particularly, to an adaptive method of clock controller and a device thereof.

### DESCRIPTION OF PRIOR ART

Because of defects of manufacturing process of liquid crystal display (LCD,) often resulting in uneven brightness in the LCD production of LCD Panel, and causing a variety of Mura (Mura is a phenomenon of a variety of signs causing by uniform display brightness.) In order to enhance the uniformity of the brightness of the LCD panel, it can take 3 to 5 Mura types of grayscale screen (different brightness of white screen) through a camera, by comparing the brightness of the center of the panel to calculate the brightness difference between the periphery and the center position, so as to obtain Mura compensation data (grayscale data.) Wherein decreasing the grayscale data to decrease the brightness in the position which is brighter than the center position; and increasing the grayscale data to increase the brightness in the position which is darker than the center position. The Mura compensation data is then burned into memory of the LCD panel by a data writer. When the LCD display is powered up, the clock controller reads the Mura compensation data from the memory and inputs the original grayscale data to calculate, the LCD panel displays the screen with the same brightness after Mura compensation.

Because of the difference in design of internal function of each clock controller manufacturer, the storage format and storage position of the Mura compensation data in the memory are different, and causing the compensation data format stored in the memory and the clock controller are only one-to-one correspondence. In other words, when the Mura compensation data is stored in memory in accordance with the requirements of clock controller of A manufacturer, the data can only be adapted to the A clock controller manufacturer to achieve the Mura compensation. If the data is adapted to B clock controller manufacturer, due to data format and storage position does not match, resulting in situations that error compensation or no compensation because of incorrect data read by the B clock controller manufacturer.

In other words, due to different clock controller manufacturers require different Mura compensation data formats, when there are multiple clock controller manufacturers, it need to redesign different data burning programs for each clock controller manufacturer, so as to burn Mura compensation data into memory by correct format of the clock controller requirements, it will increase the number of versions of the data burning program and will be error-prone to switch programs on the production line.

### SUMMARY OF THE INVENTION

The purpose of the present invention is to provide an adaptive method of clock controller and a device thereof, which can to adapt the same compensation data to different clock controllers without changing the compensation data in the memory.

In order to achieve the above purpose, the present invention is to provide an adaptive method of clock controller, wherein the method is based on a clock controller, a conversion module, and a memory, and the memory is used to store original compensation data corresponding to a liquid crystal panel, and wherein the method comprises: capturing the original compensation data from the memory by the conversion module; converting the original compensation data into updated compensation data adapted to the clock controller by the conversion module; capturing the updated compensation data from the conversion module by the clock controller and outputting a screen compensated by the updated compensation data to a liquid crystal panel; when the conversion module is a microcontroller, the specific steps of converting the original compensation data into the updated compensation data adapted to the clock controller by the conversion module are: obtaining a type corresponding to the clock controller from the clock controller by the microcontroller; capturing the updated compensation data according to the type of clock controller and the original compensation data by the microcontroller; wherein the original compensation data and the updated compensation data have the same data content, a different data content arrangement order, and/or an arrangement format; wherein the original compensation data and the updated compensation data comprise at least one of different grayscale values, different grayscale compensation values, a grayscale upper limit value, a grayscale lower limit value, and a check value of compensation value.

Wherein when the microcontroller stores a conversion program corresponding to a different type of clock controller, the steps of capturing the updated compensation data according to the type of clock controller and the original compensation data by the microcontroller are: the microcontroller determines the conversion program corresponding to the type of the clock controller, based on the type of the clock controller, and the correspondence relationship between the default clock controller type and conversion program; converting original compensation data into the updated compensation data by the microcontroller using the conversion program.

In order to achieve the above purpose, the present invention is further to provide an adaptive method of clock controller, wherein the method is based on a clock controller, a conversion module, and a memory, and the memory is used to store original compensation data corresponding to a liquid crystal panel, and wherein the method comprises: capturing the original compensation data from the memory by the conversion module; converting the original compensation data into updated compensation data adapted to the clock controller by the conversion module; capturing the updated compensation data from the conversion module by the clock controller and outputting a screen compensated by the updated compensation data to a liquid crystal panel.

Wherein when the conversion module is arranged in the clock controller, and the conversion module stores the conversion program corresponding to the type of the current clock controller, the step of converting the original compensation data into updated compensation data adapted to the clock controller by the conversion module is: converting original compensation data into the updated compensation data adapted to the clock controller by the microcontroller using the conversion program; the step of capturing the updated compensation data from the conversion module by the clock controller and outputting a screen compensated by the updated compensation data to a liquid crystal panel is: capturing the updated compensation data from the conversion module by a compensation module in the clock controller and outputting a screen compensated by the updated compensation data to a liquid crystal panel.

Wherein when the conversion module is a microcontroller, the specific steps of converting the original compensation data into the updated compensation data adapted to the clock controller by the conversion module are: obtaining a type corresponding to the clock controller from the clock controller by the microcontroller; capturing the updated compensation data according to the type of clock controller and the original compensation data by the microcontroller.

Wherein when the microcontroller stores a conversion program corresponding to a different type of clock controller, the steps of capturing the updated compensation data according to the type of clock controller and the original compensation data by the microcontroller are: the microcontroller determines the conversion program corresponding to the type of the clock controller, based on the type of the clock controller, and the correspondence relationship between the default clock controller type and conversion program; converting original compensation data into the updated compensation data by the microcontroller using the conversion program.

Wherein the original compensation data and the updated compensation data have the same data content, a different data content arrangement order, and/or an arrangement format; wherein the original compensation data and the updated compensation data comprise at least one of different grayscale values, different grayscale compensation values, a grayscale upper limit value, a grayscale lower limit value, and a check value of compensation value.

In order to achieve the above purpose, the present invention is more further to provide an adaptive device of clock controller, wherein the device comprises a clock controller, a conversion module, and a memory; the memory is used to store original compensation data corresponding to a liquid crystal panel; the conversion module is used to convert the original compensation data into the updated compensation data adapted to the clock controller after capturing the original compensation data from the memory; the clock controller used to capture he updated compensation data from the conversion module and output a screen compensated by the updated compensation data to a liquid crystal panel.

Wherein the conversion module is arranged in the clock controller, and the conversion module stores the conversion program corresponding to the type of the current clock controller, the clock controller further comprises a compensation module; wherein the compensation module captures the updated compensation data from the conversion module and outputs a screen compensated by the updated compensation data to a liquid crystal panel after converting original compensation data into the updated compensation data adapted to the clock controller by the microcontroller using the conversion program.

Wherein when the conversion module is a microcontroller, the specific operations of converting the original compensation data into the updated compensation data adapted to the clock controller by the conversion module are: obtaining a type corresponding to the clock controller from the clock controller by the microcontroller; capturing the updated compensation data according to the type of clock controller and the original compensation data by the microcontroller.

Wherein when the microcontroller stores a conversion program corresponding to a different type of clock controller, the specific operations of capturing the updated compensation data according to the type of clock controller and the original compensation data by the microcontroller are: the microcontroller determines the conversion program corresponding to the type of the clock controller, based on the type of the clock controller, and the correspondence relationship between the default clock controller type and conversion program; converting original compensation data into the updated compensation data by the microcontroller using the conversion program.

Wherein the original compensation data and the updated compensation data have the same data content, a different data content arrangement order, and/or an arrangement format; wherein the original compensation data and the updated compensation data comprise at least one of different grayscale values, different grayscale compensation values, a grayscale upper limit value, a grayscale lower limit value, and a check value of compensation value.

The present invention can be concluded with the following advantages, by capturing the original compensation data from the memory by the conversion module using the adaptive method of clock controller and a device thereof of the present invention; capturing the updated compensation data from the conversion module by the clock controller and outputting a screen compensated by the updated compensation data to a liquid crystal panel. By the above-mentioned manner, the present invention can adapt the same original compensation data to different clock controllers without changing the original compensation data in the memory.

### BRIEF DESCRIPTION OF DRAWINGS

FIG. 1 is a structural illustration of the first embodiment made in accordance to an adaptive device of clock controller in the present invention;

FIG. 2 is a structural illustration of the second embodiment made in accordance an adaptive device of clock controller in the present invention;

FIG. 3 is a structural illustration of the third embodiment made in accordance an adaptive device of clock controller in the present invention;

FIG. 4 is a flow chart of an adaptive method of clock controller of the first embodiment in the present invention;

FIG. 5 is a flow chart of an adaptive method of clock controller of the second embodiment in the present invention; and

FIG. 6 is a flow chart of an adaptive method of clock controller of the third embodiment in the present invention.

### DESCRIPTION OF PREFERRED EMBODIMENT

Technical implementation will be described below clearly and fully by combining with drawings made in accordance with an embodiment in the present invention.

FIG. 1 is a structural illustration of the first embodiment made in accordance to an adaptive device of clock controller in the present invention. As shown in FIG. 1, the device comprises a clock controller 11, a conversion module 12, and a memory 13.

The memory 13 is used to store original compensation data corresponding to a liquid crystal panel.

The conversion module 12 is connected to the memory 13, which is used to convert the original compensation data into updated compensation data adapted to the clock controller 11 after capturing the original compensation data from the memory 13.

The clock controller 11 is connected to the memory 12, which is used to capture the updated compensation data from the conversion module 12 and output a screen compensated by the updated compensation data to a liquid crystal panel.

Wherein the original compensation data and the updated compensation data have the same data content, a different data content arrangement order, and/or an arrangement format. Wherein the original compensation data and the updated compensation data comprise at least one of different grayscale values, different grayscale compensation values, a grayscale upper limit value, a grayscale lower limit value, and a check value of compensation value.

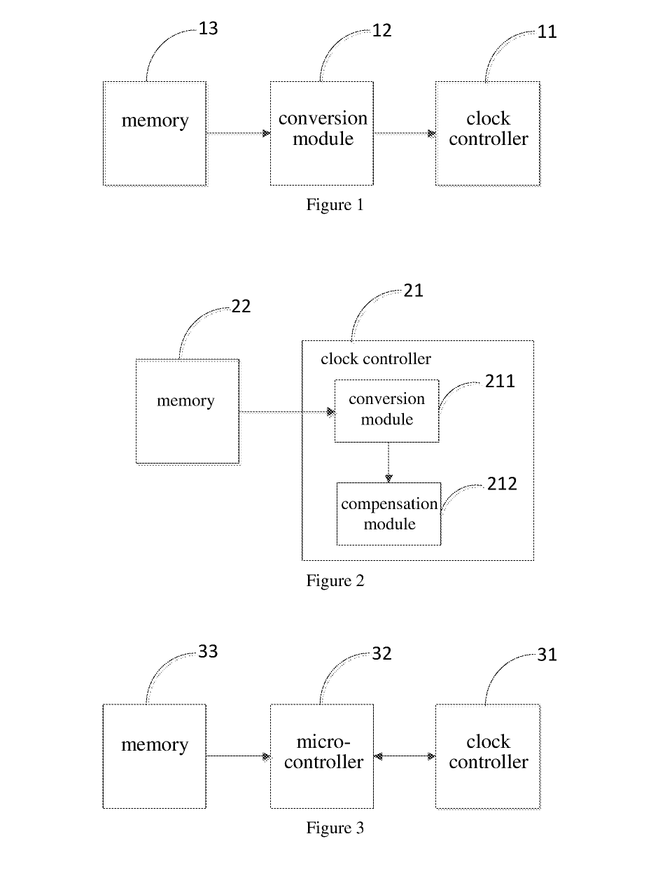

FIG. 2 is a structural illustration of the second embodiment made in accordance to an adaptive device of clock controller in the present invention. As shown in FIG. 2, the device comprises a clock controller 21 and a memory 22, wherein the clock controller 21 comprises a conversion module 211 and a compensation module 212.

The memory 22 is used to store original compensation data corresponding to a liquid crystal panel.

The conversion module 211 in the clock controller 21 is connected to the memory 22, which is used to capture the original compensation data from the memory 22 and convert the original compensation data into updated compensation data adapted to the clock controller 21. Specifically, the conversion module 211 stores the conversion program corresponding to the type of the current clock controller, the conversion program is used to convert the original compensation data into the updated compensation data corresponding to the current clock controller. That is, after the conversion module 211 captures the original compensation data, the conversion program converts the original compensation data into updated compensation data adapted to the clock controller. It should be noticed that, when the type of clock controller is different, conversion program stored in the conversion module is different from each other.

The compensation module 212 is connected to the conversion module 211, which is used to capture the updated compensation data from the conversion module 211 and output a screen compensated by the updated compensation data to a liquid crystal panel. Specifically, after the compensation module 212 receives the original grayscale data from outside and receives the updated compensation data from the conversion module 211, modified grayscale data is obtained base on the original grayscale data and updated compensation data, and a screen corresponding to the modified grayscale data is output to a liquid crystal panel, so as to achieve the LCD panel displays the screen with the same brightness after Mura compensation.

FIG. 3 is a structural illustration of the third embodiment made in accordance to an adaptive device of clock controller in the present invention. As shown in FIG. 3, the device comprises a clock controller 31, a microcontroller 32, and a memory 33, wherein the microcontroller 32 stores conversion programs corresponding to different types of clock controller, the conversion program is used to convert the original compensation data into updated compensation data corresponding to the type of clock controller.

The memory 33 is used to store original compensation data corresponding to a liquid crystal panel.

The microcontroller 32 is connected to the memory 33, which is used to convert the original compensation data into updated compensation data adapted to the clock controller after capturing the original compensation data from the memory 33. Specifically, the microcontroller 32 is connected to the clock controller 31 and the memory 33 respectively, which is used to obtain a type corresponding to the clock controller from the clock controller 31 and capture the original compensation data from the memory 33, and capturing the updated compensation data according to the type of clock controller and the original compensation data. Wherein the specific operations of capturing the updated compensation data according to the type of clock controller and the original compensation data by the microcontroller 32 are: the microcontroller 32 determines the conversion program corresponding to the type of the clock controller, based on the type of the clock controller, and the correspondence relationship between the default clock controller type and conversion program; converting original compensation data into the updated compensation data by the microcontroller 32 using the conversion program 321.

The clock controller 31 is connected to the microcontroller 32, which is used to capture the updated compensation data from the microcontroller 32 and output a screen compensated by the updated compensation data to a liquid crystal panel. Specifically, after the clock controller 31 is used to receive the original grayscale data from outside and receives the updated compensation data from the microcontroller 32, modified grayscale data is obtained base on the original grayscale data and updated compensation data, and a screen corresponding to the modified grayscale data is output to a liquid crystal panel, so as to achieve the LCD panel displays the screen with the same brightness after Mura compensation.

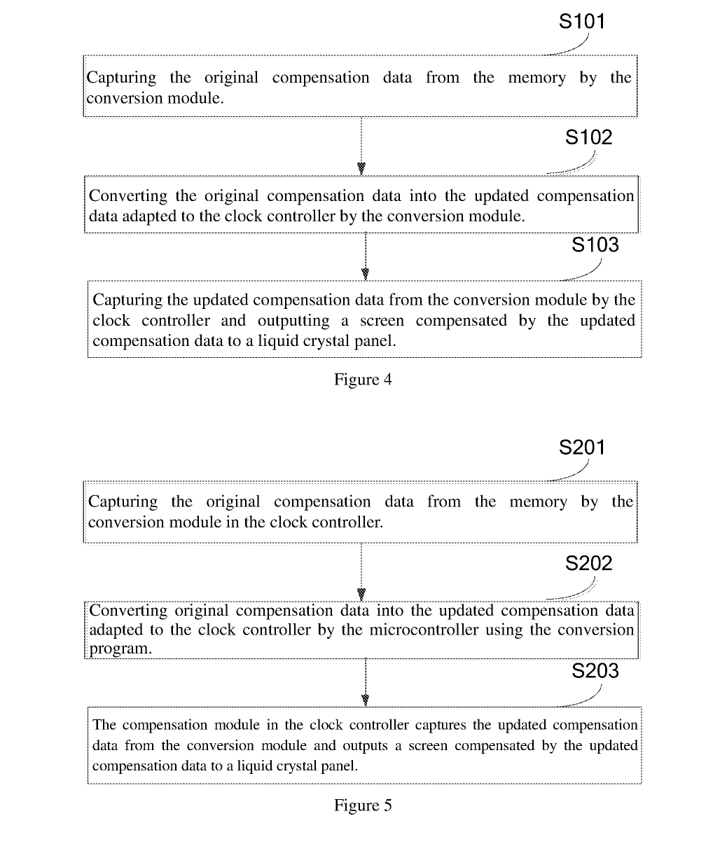

FIG. 4 is a flow chart of an adaptive method of clock controller of the first embodiment in the present invention. The method is based on the device shown in FIG. 1. As shown in FIG. 4, the method comprises:

Step S101: capturing the original compensation data from the memory by the conversion module.

In the step S101, in the present embodiment, the original compensation data is stored in the memory in the order of low address to high address sequentially, and which comprises different grayscale values, different grayscale compensation values, a grayscale upper limit value, a grayscale lower limit value, and a check value of compensation value.

Step S102: converting the original compensation data into the updated compensation data adapted to the clock controller by the conversion module.

In the step S102, in the present embodiment, the updated compensation data and the original compensation data have the same data content and a different data content arrangement order. Specifically, the updated compensation data comprises the check value of compensation value, the different grayscale values and the different grayscale compensation values stored alternately, the grayscale upper limit value, and the grayscale lower limit value. Three different grayscale values are taken for example, the different grayscale values and the different grayscale compensation values stored alternately are grayscale value 1, grayscale compensation value 1, grayscale value 2, grayscale compensation value 2, grayscale value 3, and grayscale compensation value 3.

Step S103: capturing the updated compensation data from the conversion module by the clock controller and outputting a screen compensated by the updated compensation data to a liquid crystal panel.

In the step S103, after the clock controller is used to receive the original grayscale data from outside and receives the updated compensation data from the microcontroller, modified grayscale data is obtained base on the original grayscale data and updated compensation data, and a screen corresponding to the modified grayscale data is output to a liquid crystal panel, so as to achieve the LCD panel displays the screen with the same brightness after Mura compensation.

FIG. 5 is a flow chart of an adaptive method of clock controller of the second embodiment in the present invention. The method is based on the device shown in FIG. 2. As shown in FIG. 5, the method comprises:

Step S201: capturing the original compensation data from the memory by the conversion module in the clock controller.

In the step S201, the conversion module is arranged in the clock controller, and the conversion module stores the conversion program corresponding to the type of the current clock controller, wherein the conversion program is used to convert the same original compensation data into updated compensation data corresponding to the current clock controller.

Step S202: converting original compensation data into the updated compensation data adapted to the clock controller by the microcontroller using the conversion program.

Step S203: the compensation module in the clock controller captures the updated compensation data from the conversion module and outputs a screen compensated by the updated compensation data to a liquid crystal panel.

In the step S201, when the conversion module converts the original compensation data into the updated compensation data, the updated compensation data is transmitted to the compensation module in the clock controller to compensate the original grayscale data, so as display panel displays the screen with the same brightness.

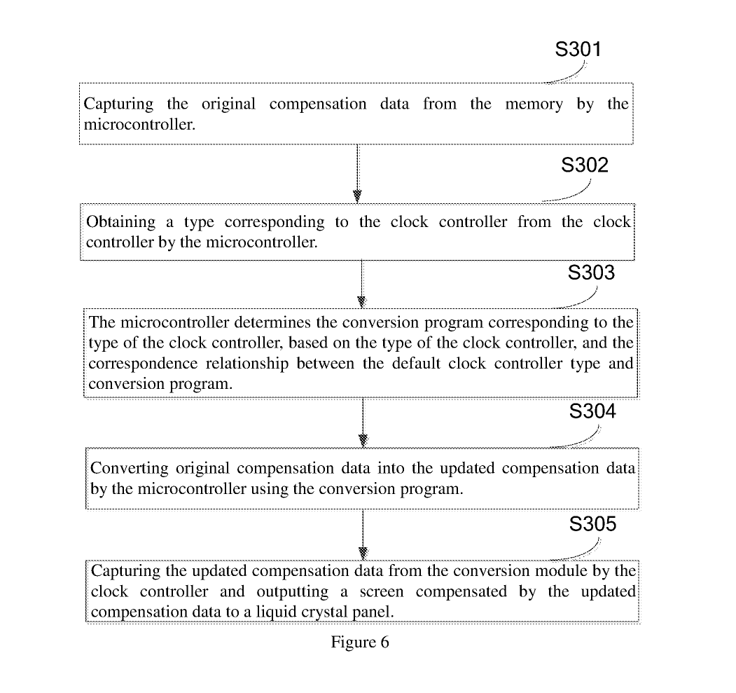

FIG. 6 is a flow chart of an adaptive method of clock controller of the third embodiment in the present invention. The method is based on the device shown in FIG. 3. As shown in FIG. 6, the method comprises:

Step S301: capturing the original compensation data from the memory by the microcontroller.

In the step S301, the microcontroller is a component which is independent of the memory and the clock controller, wherein the microcontroller stores conversion programs corresponding to different types of clock controller.

Step S302: obtaining a type corresponding to the clock controller from the clock controller by the microcontroller.

Step S303: the microcontroller determines the conversion program corresponding to the type of the clock controller, based on the type of the clock controller, and the correspondence relationship between the default clock controller type and conversion program.

In the step S303: when the microcontroller obtains the type of the clock controller, selects a conversion program corresponding to the type of the clock controller to convert the original compensation data into the updated compensation data corresponding to the type of the clock controller.

Step S304: converting original compensation data into the updated compensation data by the microcontroller using the conversion program.

Step S305: capturing the updated compensation data from the conversion module by the clock controller and outputting a screen compensated by the updated compensation data to a liquid crystal panel.

The present invention can be concluded with the following advantages, by capturing the original compensation data from the memory by the conversion module using the adaptive method of clock controller and a device thereof of the present invention; capturing the updated compensation data from the conversion module by the clock controller and outputting a screen compensated by the updated compensation data to a liquid crystal panel. By the above-mentioned manner, the present invention can adapt the same original compensation data to different clock controllers without changing the original compensation data in the memory.

Embodiments of the present invention have been described, but not intending to impose any unduly constraint to the appended claims. Any modification of equivalent structure or equivalent process made according to the disclosure and drawings of the present invention, or any application thereof, directly or indirectly, to other related fields of technique, is considered encompassed in the scope of protection defined by the claims of the present invention.

1. An adaptive method of clock controller, wherein the method is based on a clock controller, a conversion module, and a memory, and the memory is used to store original compensation data corresponding to a liquid crystal panel, and wherein the method comprises:
capturing the original compensation data from the memory by the conversion module;
converting the original compensation data into updated compensation data adapted to the clock controller by the conversion module;
capturing the updated compensation data from the conversion module by the clock controller and outputting a screen compensated by the updated compensation data to a liquid crystal panel;
wherein when the conversion module is a microcontroller, the specific steps of converting the original compensation data into the updated compensation data adapted to the clock controller by the conversion module are:
obtaining a type corresponding to the clock controller from the clock controller by the microcontroller;
capturing the updated compensation data according to the type of clock controller and the original compensation data by the microcontroller;
wherein the original compensation data and the updated compensation data have the same data content, a different data content arrangement order, and/or an arrangement format;
wherein the original compensation data and the updated compensation data comprise at least one of different grayscale values, different grayscale compensation values, a grayscale upper limit value, a grayscale lower limit value, and a check value of compensation value.

2. The method as recited in claim 1, wherein when the microcontroller stores a conversion program corresponding to a different type of clock controller, the steps of capturing the updated compensation data according to the type of clock controller and the original compensation data by the microcontroller are:
the microcontroller determining the conversion program corresponding to the type of the clock controller, based on the type of the clock controller, and the correspondence relationship between the default clock controller type and conversion program;
converting original compensation data into the updated compensation data by the microcontroller using the conversion program.

3. An adaptive method of clock controller, wherein the method is based on a clock controller, a conversion module, and a memory, and the memory is used to store original compensation data corresponding to a liquid crystal panel, and wherein the method comprises:
capturing the original compensation data from the memory by the conversion module;
converting the original compensation data into updated compensation data adapted to the clock controller by the conversion module;
capturing the updated compensation data from the conversion module by the clock controller and outputting a screen compensated by the updated compensation data to a liquid crystal panel.

4. The method as recited in claim 3, wherein when the conversion module is arranged in the clock controller, and the conversion module stores the conversion program corresponding to the type of the current clock controller, the step of converting the original compensation data into updated compensation data adapted to the clock controller by the conversion module is:
converting original compensation data into the updated compensation data adapted to the clock controller by the microcontroller using the conversion program;
wherein the step of capturing the updated compensation data from the conversion module by the clock controller and outputting a screen compensated by the updated compensation data to a liquid crystal panel is:
capturing the updated compensation data from the conversion module by a compensation module in the clock controller and outputting a screen compensated by the updated compensation data to a liquid crystal panel.

5. The method as recited in claim 3, wherein when the conversion module is a microcontroller, the specific steps of converting the original compensation data into the updated compensation data adapted to the clock controller by the conversion module are:
obtaining a type corresponding to the clock controller from the clock controller by the microcontroller;
capturing the updated compensation data according to the type of clock controller and the original compensation data by the microcontroller.

6. The method as recited in claim 5, wherein when the microcontroller stores a conversion program corresponding to a different type of clock controller, the steps of capturing the updated compensation data according to the type of clock controller and the original compensation data by the microcontroller are:
the microcontroller determining the conversion program corresponding to the type of the clock controller, based on the type of the clock controller, and the correspondence relationship between the default clock controller type and conversion program;
converting original compensation data into the updated compensation data by the microcontroller using the conversion program.

7. The method as recited in claim 3, wherein the original compensation data and the updated compensation data have the same data content, a different data content arrangement order, and/or an arrangement format;
wherein the original compensation data and the updated compensation data comprise at least one of different grayscale values, different grayscale compensation values, a grayscale upper limit value, a grayscale lower limit value, and a check value of compensation value.

8. An adaptive device of clock controller, wherein the device comprises a clock controller, a conversion module, and a memory;
the memory is used to store original compensation data corresponding to a liquid crystal panel;
the conversion module used to convert the original compensation data into the updated compensation data adapted to the clock controller after capturing the original compensation data from the memory;
the clock controller used to capture he updated compensation data from the conversion module and output a screen compensated by the updated compensation data to a liquid crystal panel.

9. The device as recited in claim 8, wherein the conversion module is arranged in the clock controller, and the conversion module stores the conversion program corresponding to the type of the current clock controller, the clock controller further comprises a compensation module;
wherein the compensation module captures the updated compensation data from the conversion module and outputs a screen compensated by the updated compensation data to a liquid crystal panel after converting original compensation data into the updated compensation data adapted to the clock controller by the microcontroller using the conversion program.

10. The device as recited in claim 8, wherein when the conversion module is a microcontroller, the specific operations of converting the original compensation data into the updated compensation data adapted to the clock controller by the conversion module are:
obtaining a type corresponding to the clock controller from the clock controller by the microcontroller;
capturing the updated compensation data according to the type of clock controller and the original compensation data by the microcontroller.

11. The device as recited in claim 10, wherein when the microcontroller stores a conversion program corresponding to a different type of clock controller, the specific operations of capturing the updated compensation data according to the type of clock controller and the original compensation data by the microcontroller are:
the microcontroller determining the conversion program corresponding to the type of the clock controller, based on the type of the clock controller, and the correspondence relationship between the default clock controller type and conversion program;
converting original compensation data into the updated compensation data by the microcontroller using the conversion program.

12. The device as recited in claim 8, wherein the original compensation data and the updated compensation data have the same data content, a different data content arrangement order, and/or an arrangement format;
wherein the original compensation data and the updated compensation data comprise at least one of different grayscale values, different grayscale compensation values, a grayscale upper limit value, a grayscale lower limit value, and a check value of compensation value.
